(19) United States
(12) Patent Application Publication
(10) Pub. No.: US 2026/0208634 A1
(43) Pub. Date: Jul. 23, 2026

(54) CHILD RESTRAINT INCLUDING A HARNESS STRAP ANCHOR

(71) Applicant: Dorel Juvenile Group, Inc., Foxboro, MA (US)

(72) Inventors: Cody Allen NASH-KNIFFEN, Shelbyville, IN (US); Darshan RACCA, Carmel, IN (US)

(21) Appl. No.: 19/455,186

(22) Filed: Jan. 21, 2026

Related U.S. Application Data
(60) Provisional application No. 63/747,538, filed on Jan. 21, 2025.

(51) Int. Cl. B60N 2/26; B60N 2/28

(52) U.S. Cl. CPC B60N 2/265; B60N 2/28

(57) ABSTRACT

A child restraint includes a juvenile vehicle seat adapted to be secured to a vehicle seat and a child restraint harness coupled to the juvenile vehicle seat. The juvenile vehicle seat is formed to include a child-receiving space configured to hold a child for transportation in a vehicle. The child-restraint harness is configured to secure the child to the juvenile vehicle seat.

### PRIORITY CLAIM

This application claims priority under 35 U.S.C. § 119(e) to U.S. Provisional Ser. No. 63/747,538 , filed Jan. 21, 2025, which is expressly incorporated by reference herein in its entirety.

### BACKGROUND

The present disclosure relates to a child safety device, and particularly to a child restraint. More particularly, the present disclosure relates to a child restraint configured to secure a child for transportation, such as in a vehicle or to or in a stroller.

### SUMMARY

According to the present disclosure, a child restraint includes a juvenile vehicle seat adapted to be secured to a vehicle seat and a child restraint harness coupled to the juvenile vehicle seat. The juvenile vehicle seat is formed to include a child-receiving space configured to hold a child for transportation in a vehicle. The child-restraint harness is configured to secure the child to the juvenile vehicle seat.

In illustrative embodiments, the child-restraint harness includes a crotch strap, a first shoulder strap, a second shoulder strap, and a strap retainer configured to attach selectively the first shoulder strap and the second shoulder strap to the crotch strap. The strap retainer includes a crotch buckle coupled to the crotch strap, a first shoulder-strap anchor coupled to the first shoulder strap, and a second shoulder-strap anchor coupled to the second shoulder strap. The first and second shoulder-strap anchors each include an anchor mount coupled to the first shoulder strap and the second shoulder strap, respectively, and an anchor latch coupled to each respective anchor mount. The anchor latches are configured to engage selectively with the crotch buckle to block separation of the first and second shoulder-strap anchors from the crotch buckle.

In illustrative embodiments, each anchor mount is formed to include a first strap-receiving slot and a second strap-receiving slot. The first shoulder strap and the second shoulder strap are threaded through the first strap-receiving slot and the second strap-receiving slot of each respective anchor mount to apply a friction force between each anchor mount and the first shoulder strap and the second shoulder strap, respectively, to block movement of each anchor mount along the first shoulder strap and the second shoulder strap, respectively. This holds the strap anchors in a position of last use to allow a caregiver to more easily retrieve and install the strap anchors after a child is placed in the child-receiving space.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective and diagrammatic view of a child restraint including a juvenile vehicle seat configured to be attached to a vehicle seat and a child-restraint harness coupled to the juvenile vehicle seat and configured to secure a child to the juvenile vehicle seat;

FIG. 2 is an enlarged view of a portion of the child restraint of FIG. 1 showing the child-restraint harness including a crotch strap, a first shoulder strap, a second shoulder strap, and a strap retainer having a crotch buckle coupled to the crotch strap, a first strap anchor coupled to the first shoulder strap, and a second strap anchor coupled to the second shoulder strap, and showing that each strap anchor is formed to include a first strap-receiving slot and a second strap receiving slot to provide a tortuous weave path for each respective shoulder strap so that the strap anchors impart a friction force on the shoulder straps to retain each strap anchor in a position of last use and facilitate retrieval of the strap anchors after a child is placed in the juvenile vehicle seat;

FIG. 3 is a perspective view of a portion of the child restraint of FIG. 1 showing one of the strap anchors retained in a position of last use;

FIG. 4 is a perspective view of one of the strap anchors including an anchor mount formed to include the first and second strap-receiving slots and an anchor latch configured to couple selectively with the crotch buckle;

FIG. 5 is a cross section of the strap anchor of FIG. 4 taken along line 5-5 showing one of the shoulder straps woven through the first and second strap-receiving slots;

FIG. 6 is an exploded assembly view of the strap anchor of FIG. 4 showing the strap anchor including a metallic material providing the anchor latch and a portion of the anchor mount and a mount cover including a polymeric material configured to cover portions of the metallic material;

FIG. 7 is a cross section of the strap anchor of FIG. 4 taken along line 7-7 showing the mount cover encapsulating portions of the metallic material in the anchor mount;

FIG. 8 is a perspective view of a second embodiment of a mount cover for a left side strap anchor formed to include a first strap-receiving slot and a second strap-receiving slot;

FIG. 9 is an exploded assembly view of the mount cover of FIG. 8 including a front segment and a rear segment;

FIG. 10 is a perspective view of a mount cover for a right side strap anchor formed to include a first strap-receiving slot and a second strap-receiving slot;

FIG. 11 is an exploded assembly view of the mount cover of FIG. 10 including a front segment and a rear segment;

FIG. 12 is a perspective view of a strap anchor;

FIG. 13 is a front view of the strap anchor of FIG. 12;

FIG. 14 is a rear view of the strap anchor of FIG. 12;

FIG. 15 is a left side view of the strap anchor of FIG. 12;

FIG. 16 is a right side view of the strap anchor of FIG. 12;

FIG. 17 is a top view of the strap anchor of FIG. 12;

FIG. 18 is a bottom view of the strap anchor of FIG. 12;

FIG. 19 is a perspective view of a second embodiment of a strap anchor;

FIG. 20 is a front view of the strap anchor of FIG. 19;

FIG. 21 is a rear view of the strap anchor of FIG. 19;

FIG. 22 is a left side view of the strap anchor of FIG. 19;

FIG. 23 is a right side view of the strap anchor of FIG. 19;

FIG. 24 is a top view of the strap anchor of FIG. 19;

FIG. 25 is a bottom view of the strap anchor of FIG. 19;

FIG. 26 is a perspective view of a third embodiment of a strap anchor;

FIG. 27 is a front view of the strap anchor of FIG. 26;

FIG. 28 is a rear view of the strap anchor of FIG. 26;

FIG. 29 is a left side view of the strap anchor of FIG. 26;

FIG. 30 is a right side view of the strap anchor of FIG. 26;

FIG. 31 is a top view of the strap anchor of FIG. 26;

FIG. 32 is a bottom view of the strap anchor of FIG. 26;

FIG. 33 is a perspective view of a fourth embodiment of a strap anchor;

FIG. 34 is a front view of the strap anchor of FIG. 33;

FIG. 35 is a rear view of the strap anchor of FIG. 33;

FIG. 36 is a left side view of the strap anchor of FIG. 33;

FIG. 37 is a right side view of the strap anchor of FIG. 33;

FIG. 38 is a top view of the strap anchor of FIG. 33;

FIG. 39 is a bottom view of the strap anchor of FIG. 33;

FIG. 40 is a perspective view of a fifth embodiment of a strap anchor;

FIG. 41 is a front view of the strap anchor of FIG. 40;

FIG. 42 is a rear view of the strap anchor of FIG. 40;

FIG. 43 is a left side view of the strap anchor of FIG. 40;

FIG. 44 is a right side view of the strap anchor of FIG. 40;

FIG. 45 is a top view of the strap anchor of FIG. 40; and

FIG. 46 is a bottom view of the strap anchor of FIG. 40.

### DETAILED DESCRIPTION

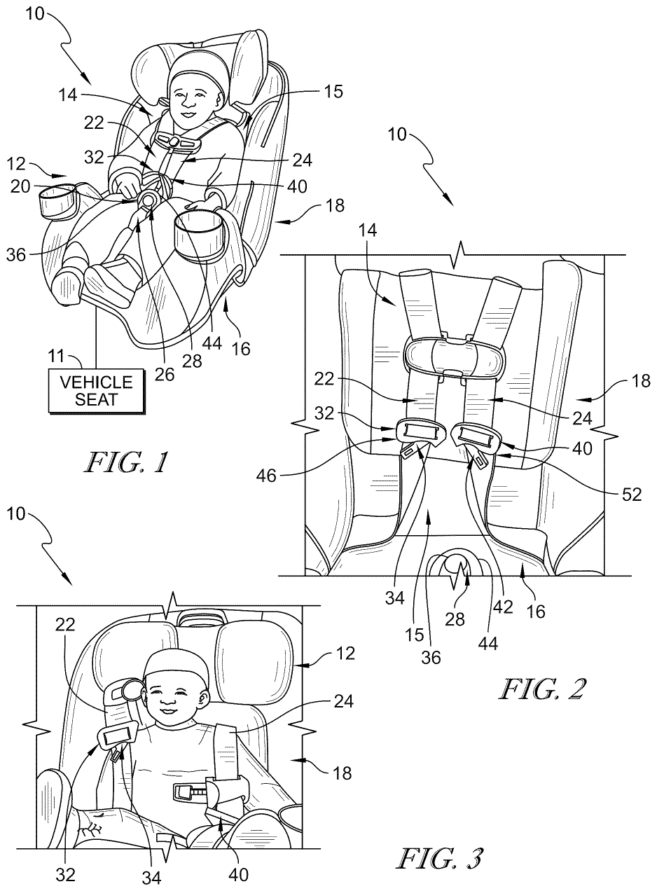

A child restraint 10 includes a juvenile vehicle seat 12 and a child-restraint harness 14 coupled to the juvenile vehicle seat 12 as shown in FIGS. 1-3. The juvenile vehicle seat 12 is adapted to be secured to a vehicle seat 11 and formed to include a child-receiving space 15 configured to hold a child for transportation in a vehicle. The child-restraint harness 14 is configured to secure the child to the juvenile vehicle seat within the child-receiving space 15.

The child-restraint harness 14 includes a crotch strap 26, a first shoulder strap 22, a second shoulder strap 24, and a strap retainer 20 as shown in FIGS. 1-3. The crotch strap 26 is fixed to the juvenile vehicle seat 12. The first shoulder strap 22 is fixed the juvenile vehicle seat 12 and spaced apart from the crotch strap 26. The second shoulder strap 24 is fixed to the juvenile vehicle seat 12 and spaced apart from the crotch strap 26 and the first shoulder strap 22. The strap retainer 20 is configured to attach selectively the first shoulder strap 22 and the second shoulder strap 24 to the crotch strap 26.

The strap retainer 20 includes a crotch buckle 28 coupled to the crotch strap, a first shoulder-strap anchor 32 coupled to the first shoulder strap 22, and a second shoulder-strap anchor 40 coupled to the second shoulder strap 24 as shown in FIGS. 1-3. The first and second shoulder-strap anchors 32, 40 are configured to engage selectively with the crotch buckle 28 to retain the child-restraint harness 14 in a closed position around a child in the child-receiving space 15.

The first and second shoulder-strap anchors 32, 40 each include an anchor mount 46, 52 coupled to the first shoulder strap 22 and the second shoulder strap 24, respectively, and an anchor latch 34, 42 coupled to each respective anchor mount 46, 52 and configured to engage selectively with the crotch buckle 28 to block separation of the first and second shoulder-strap anchors 32, 40 from the crotch buckle 28. Each anchor mount 46, 52 is formed to include a first strap-receiving slot 48 and a second strap-receiving slot 50. The first shoulder strap 22 and the second shoulder strap 24 are threaded through the first strap-receiving slot 48 and the second strap-receiving slot 50 of each anchor mount 46, 52, respectively, to apply a friction force between each anchor mount 46, 52 and the first shoulder strap 22 and the second shoulder strap 24, respectively, to block movement of each anchor mount 46, 52 along the first shoulder strap 22 and the second shoulder strap 24, respectively.

Including two strap-receiving slots 48, 52 provides a slight frictional force on the strap anchors 32, 40 so that the strap anchors 32, 40 are retained by the slight frictional force relative to the shoulder straps 22, 24. Other comparative child-restraint harnesses include mounts with only one slot formed therein to allow free movement of the mount relative to the shoulder straps. Such mounts tend to drop by gravity to a low point along the shoulder straps when not in use. The child may sit on the mounts when the child is placed in the juvenile vehicle seat, and a caregiver then needs to fish the mounts from beneath the child for installation. Such mounts also tend to fold or twist relative to the mount which can hinder installation. Retaining the strap anchors 32, 40 at a position of last use along the shoulder straps 22, 24 avoids these pitfalls.

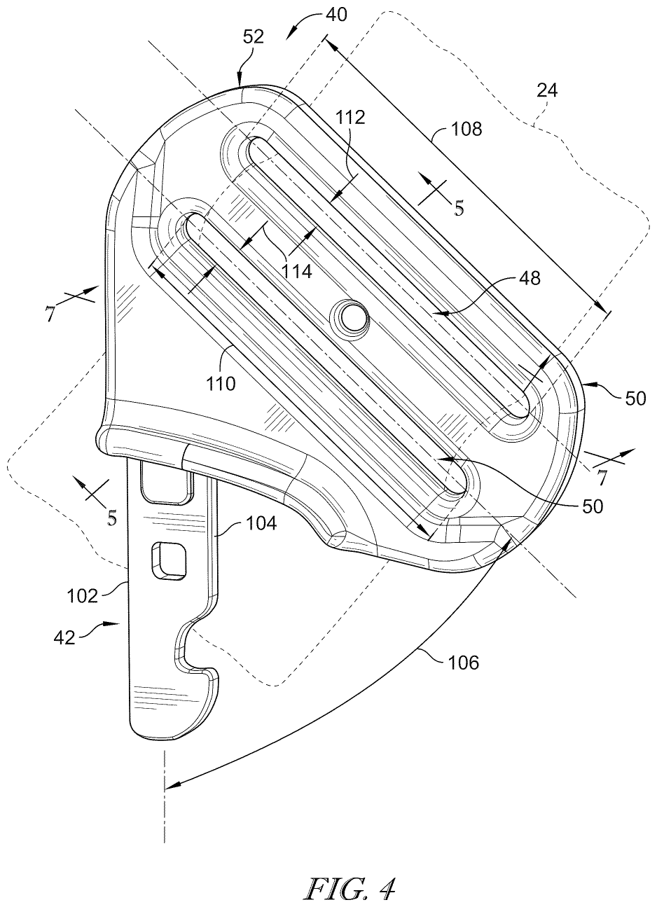

Each anchor latch 34, 42 includes a first lateral edge 102 and an opposite second lateral edge 104 as shown in FIG. 4. The first and second lateral edges 102, 104 each have a linear segment along at least a portion of an extent thereof. The first and second strap-receiving slots 48, 50 are arranged to lie at an acute angle 106 relative to the linear segments when measured in a lateral direction away from each respective anchor latch 34, 42 and toward the first and second strap-receiving slots 48, 50. The acute angle is within a range of about 45 degrees to about 55 degrees. In the illustrative embodiment, the acute angle is about 50 degrees. In some embodiments, the acute angle 106 may be within a range of about 40 degrees to about 60 degrees. In some embodiments, the acute angle 106 may be within a range of about 30 degrees to about 60 degrees. The term about is used to account for minor tolerances and measurement inaccuracies and can include values within 1 degree of the stated value. In some embodiments, the first and second strap-receiving slots 48, 50 may be arranged at different angles to the first and second laterals edges 102, 104 within the ranges described above.

The first and second strap-receiving slots 48, 50 are parallel to one another as shown in FIG. 4. The first and second strap-receiving slots 48, 50 have substantially equal lengths 108, 110 and widths 112, 114. In some embodiments, one of the strap-receiving slots 48, 50 may have a smaller length or width than the other. The term substantially is used to account for minor tolerances and measurement inaccuracies and can include values within 1 percent of the stated value. In some embodiments, the first and second strap-receiving slots 48, 50 may not be parallel to one another. In some embodiments, one or both of the first and second strap-receiving slots 48, 50 may not be linear and one or both of the first and second strap-receiving slots 48, 50 may be curved so as to be concave or convex relative to each respective latch 34, 42.

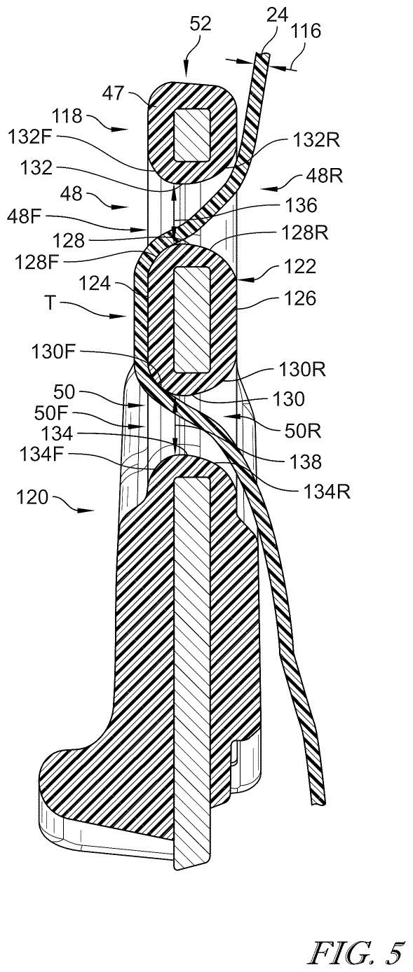

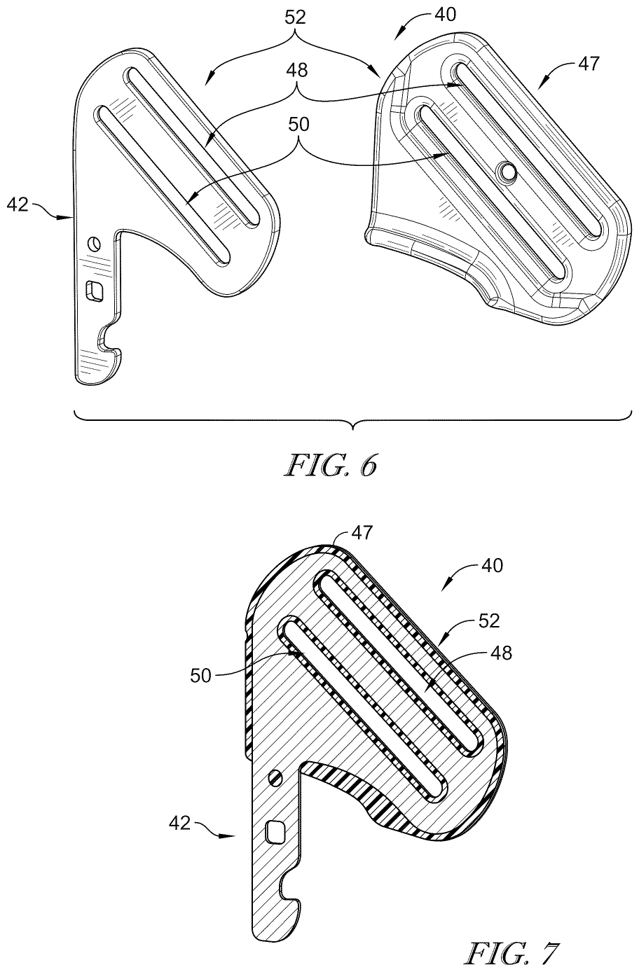

The first and second shoulder straps 22, 24 have a thickness 116 that is no more than 90% of the widths 112, 114 of the first and second strap-receiving slots 48, 50 as shown in FIG. 5. In some embodiments, the thickness 116 is no more than 80% of the widths 112, 114. In some embodiments, the thickness 116 is no more than 70% of the widths 112, 114. In some embodiments, the thickness 116 is no more than 60% of the widths 112, 114. In some embodiments, the thickness 116 is no more than 50% of the widths 112, 114. Such width 116 ensures the shoulder straps 22, 24 are not pinched by the anchor mounts 46, 52 within the strap-receiving slots 48, 50 to reduce friction on the shoulder straps 22, 24. Instead, the friction force is applied to the shoulder straps 22, 24 by a tortuous thread path T through the first and second strap-receiving slots 48, 50 as shown in FIG. 5. In some embodiments, the friction force may be predetermined and the predetermined friction force can be overcome by applying a force on the strap anchor 32, 40 of at least 0.2 lb and no more than 5 lbs in a lengthwise direction of the strap 22, 24 to cause translation of the strap anchor 32, 40 relative to the strap 22, 24.

For each strap anchor 32, 40, at least a portion of the anchor mount 46, 52 and the anchor latch 34, 42 are formed integrally with one another and are made of at least one metal material. The anchor latches 34, 42 may consist of the at least one metal material while the anchor mounts 46, 52 include the at least one metal material and one or more other materials. For example, the anchor mounts 46, 52 further include a mount cover 47 made of one or more polymeric materials. The mount cover 47 is overmolded in a hot, fluid state onto the at least one metal material such that, once cooled, the mount cover 47 is a monolithic component encapsulating a portion of the at least one metal material as shown in FIGS. 5 and 7. In some embodiments, the mount cover 47 may be formed into a plurality of separate components and subsequently assembled in a solid, cooled state around a portion of the at least one metal material.

Each anchor mount 46, 52 includes an upper segment 118 partially defining the first strap-receiving slot 48, a lower segment 120 coupled to the anchor latch 34, 42 and partially defining the second strap-receiving slot 50, and a medial segment 122 spaced apart from the upper segment 118 and the lower segment 120. The medial segment 122 is located between the first and second strap-receiving slots 48, 50 and partially defines the first strap-receiving slot 48 and the second strap-receiving slot 50.

The medial segment 122 includes, a front planar edge 124, a rear planar edge 126, an upper curved edge 128, and a lower curved edge 130 as shown in FIG. 5. The upper curved edge 128 extends between upper ends of the front and rear planar edges 124, 126. The lower curved edge 130 extends between lower ends of the front and rear planar edges 124, 126. The upper curved edge 128 and the lower curved edge 130 each include a forward end 128F, 130F having a first radius of curvature and a rear end 128R, 130R having a second radius of curvature greater than the first radius of curvature. This structure provides more friction at the forward end 128F, 130F of the curved edges 128, 130 where the straps 22, 24 extend around the medial segment 122 to increase friction between the straps 22, 24 and the medial segment 122 while still providing spacing between the straps 22, 24 and the upper and lower segments 124, 126.

The upper segment 118 has a lower curved edge 132 and the lower segment 120 has an upper curved edge 134 as shown in FIG. 5. The curved edges 128, 130, 132, 134 provide the first and second strap-receiving slots 48, 50 with a funnel-shaped forward end 48F, 50F and a funnel-shaped rear end 48R, 50R. This structure helps guide the straps 22, 24 around the medial segment 122 to facilitate translation of the strap anchors 32, 40 along the straps 22, 24 while the tortuous path T retains the strap anchors 32, 40 in place absent a force sufficient to overcome the friction force. The funnel-shaped forward end 48F, 50F and the funnel-shaped rear end 48R, 50R also facilitate threading the straps 22, 24 through the strap-receiving slots 48, 50.

The lower curved edge 132 of the upper segment 118 and the upper curved edge 134 of the lower segment 120 each include a forward end 132F, 134F having the first radius of curvature and a rear end 132R, 134R having the second radius of curvature. This structure provides the first and second strap-receiving slots 48, 50 with a smallest width 136, 138 located closer to the front planar edge 124 than the rear planar edge 126. In this way, surfaces defining the first and second strap-receiving slots 48, 50 guide the straps 22, 24 around the medial segment 122 while at least the medial segment 122 and/or the tortuous path T provide the predetermined friction force. In some embodiments, the smallest widths 136, 138 may be offset from one another relative to the front and rear of the strap anchors 32, 40 and/or different from one another (i.e. larger or smaller).

A child restraint 10 includes a juvenile seat 12 and a child-restraint harness 14 coupled to the juvenile seat 12 and adapted to be changed by a caregiver from a closed child-restraining mode shown in FIG. 1 to an opened child-seating-and-releasing mode shown in FIGS. 2 and 3. The juvenile seat 12 includes a seat bottom 16 and a seat back 18 arranged to extend upwardly from the seat bottom 16. The child-restraint harness 14 includes strap anchors 32 or 40 configured to cause friction between the strap anchor 32 or 40 and side straps 30 or 38 of the child-restraint harness 14 while lock tabs 34 or 42 is disengaged from a buckle 28 of the child-restraint harness 14 so that the strap anchors 32 or 40 is blocked from slipping downward along the side strap 30 or 38 toward the seat bottom 16. The strap anchor 32 or 40 has a first strap-receiver slot 48 and a second strap-receiver slot 50 that the side strap 30 or 38 is weaved through to take on friction between the strap anchor 32 or 40 and the side strap 30 or 38. The first strap-receiver slot 48 and the second strap-receiver slot 50 also block twisting of the side strap 30 or 38 within one of the strap-receiver slots 48, 50.

As shown in FIGS. 1-3, the child-restraint harness 14 includes a crotch belt coupled to the seat bottom, a first side belt 22 coupled to the seat back 18 and adapted to be coupled to the crotch belt to restraint the right side of a child seated in the juvenile seat 12, and a second side belt 24 coupled to seat back 18 and adapted to be coupled to the crotch belt to restraint the left side of a child seated in the juvenile seat 12.

In illustrative embodiments, in a closed child-restraining mode of the child-restraint harness 14, the first and second side belts 22, 24 are engaged to the crotch belt to cooperate with the crotch belt to restrain a child seated in the juvenile seat 12. In an opened child-seating-and-releasing mode of the child-restraint harness 14, the first and second side belts 22, 24 are disengaged from the crotch belt to provide lateral separation between the first and second side belts 22, 24 so that an open child-receiving space 15 is provided above the seat bottom 16 and between the first and second side belts 22, 24 to allow a caregiver to seat a child to be restrained on the juvenile seat 12. Once the child is seated, the first and second side belts 22, 24 are re-engaged to the crotch belt to re-establish the closed child-restraining mode of the child-restraint harness 14.

The crotch belt may include a crotch strap coupled to the seat bottom 16 and a buckle coupled to a free end of the crotch strap as suggested in FIG. 1. The first side belt 22 may include a first side strap and a first strap anchor 32 coupled to the first side strap 30 and formed to include a first lock tab 34 sized to be inserted into and retained in a first tab-receiving socket 36 formed in the buckle 28 of the crotch belt 20. The second side belt 24 may include a second side strap and a second strap anchor 40 coupled to the second side strap 38 and formed to include a second lock tab 42 sized to be inserted into and retained in a second tab-receiving socket 44 formed in the buckle 28 of the crotch belt 20. Engagement of the lock tabs 34, 42 in the corresponding tab-receiving sockets 36, 44 of the buckle 28 causes first and second side belts 22, 24 to be coupled to the crotch belt 20 to establish the closed child-restraining mode of the child restraint harness 14. A child seated in juvenile seat 12 is restrained by the child-restraint harness 14 when the lock tab 34 or 42 of each strap anchor 32 or 40 is mated with the buckle 28 of the crotch belt.

In illustrative embodiments, a caregiver can change the child-restraint harness 14 to the child-seating-and-releasing mode shown in FIGS. 2-3 by disengaging each of the lock tabs 34, 42 included in the side belts 22, 24 from the buckle 28 of the crotch belt and moving the lock tabs 34, 42 relative to the juvenile seat 12 away from the torso of the child 11. This causes the first and second side straps 30, 38 included in the side belts 22, 24 to be moved to laterally separated positions above the seat bottom 16 so that the side straps 30, 38 are out of the way and do not interfere with the process of seating a child 11 on the juvenile seat 12 or releasing a child 11 from the juvenile seat 12.

The first strap anchor 32 may include a first base or mount cover 246 formed to include a first strap-receiver slot 48 and a second strap-receiver slot 50 and the first lock tab 34 may be cantilevered to a middle section of the first base as shown FIGS. 2-5. The first side strap is passed through and slides in the first strap-receiver slot 48 and the second strap-receiver slot 50 formed in the first base. In illustrative embodiments, the first lock tab 34 is made of a metal material and the first base is made of a plastics material.

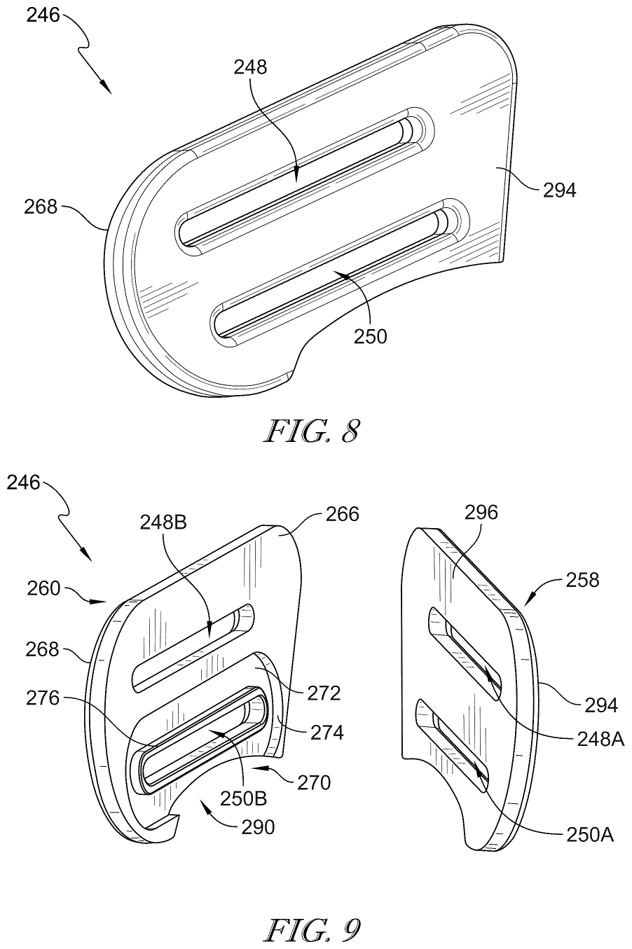

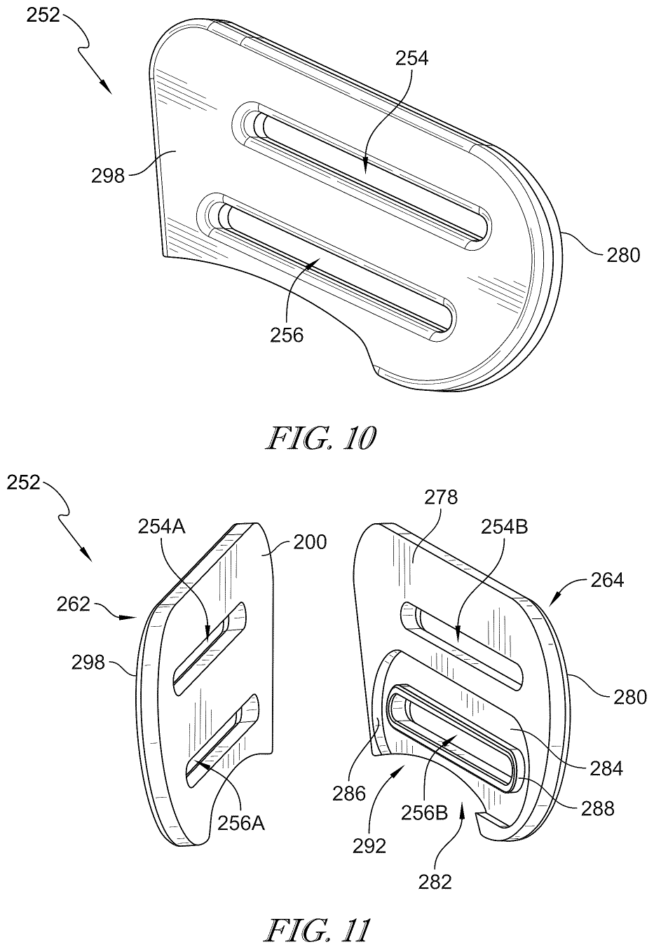

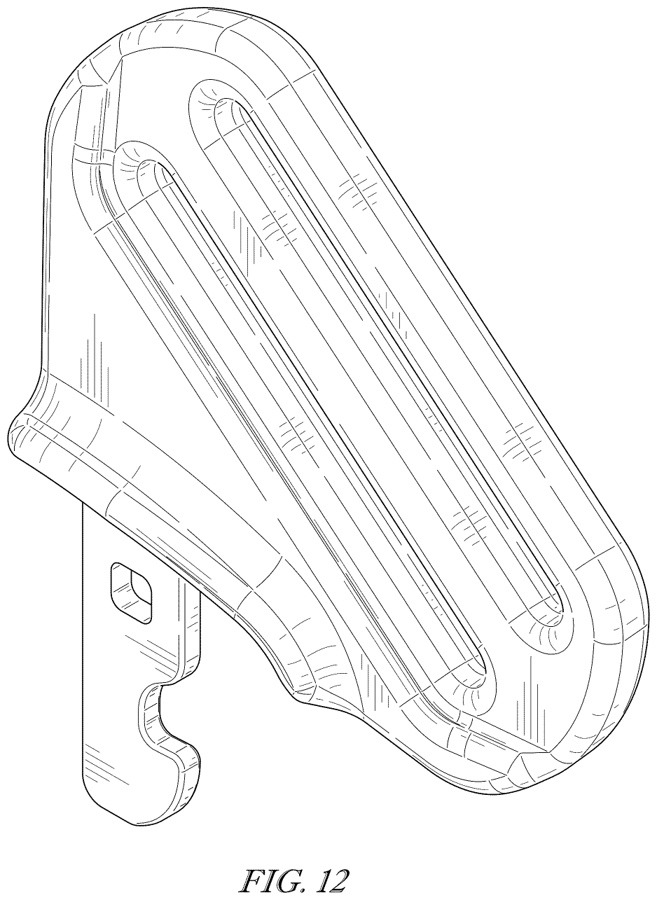

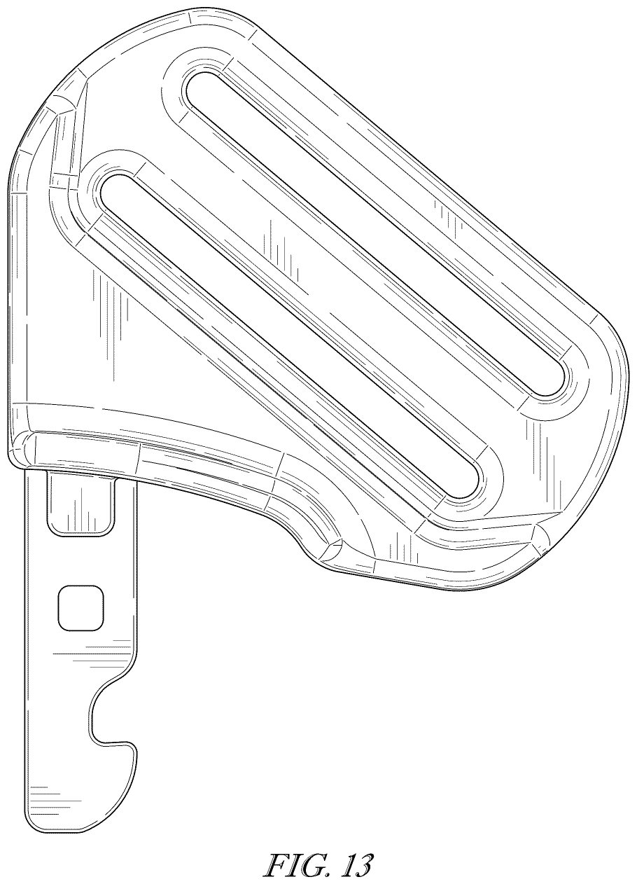

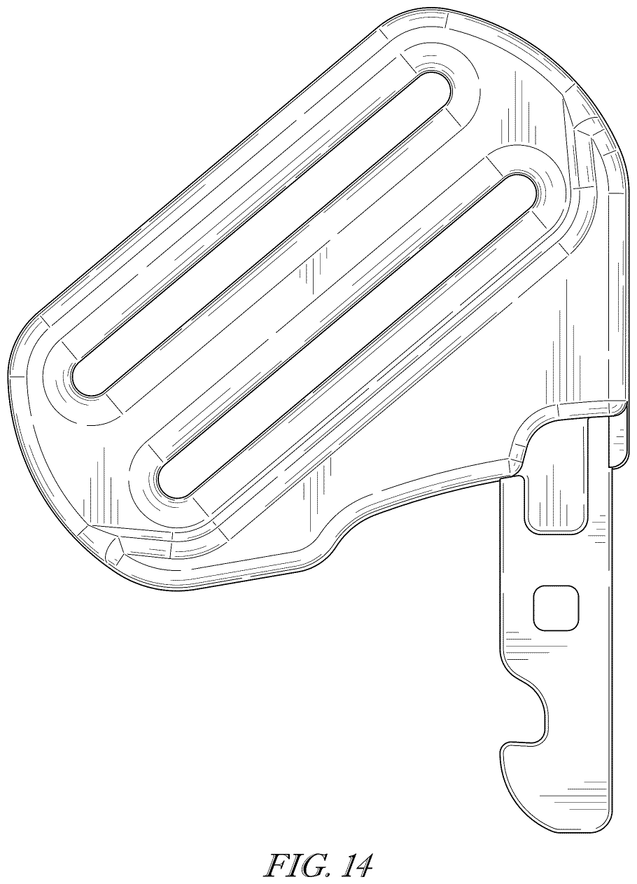

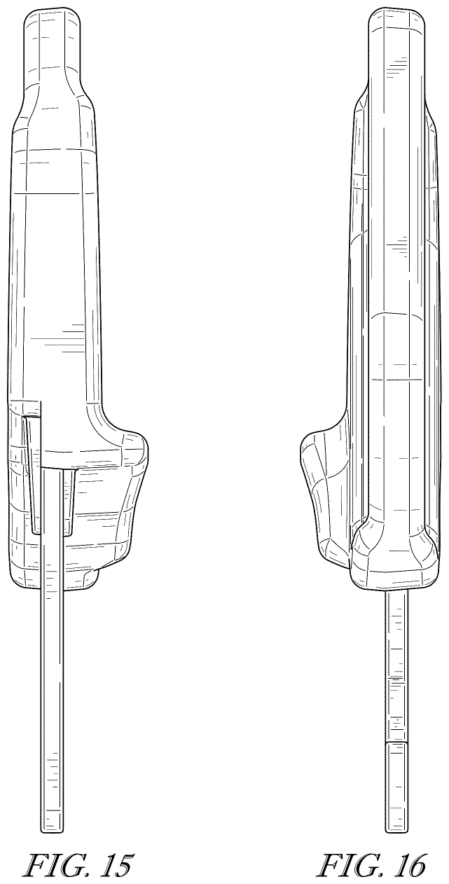

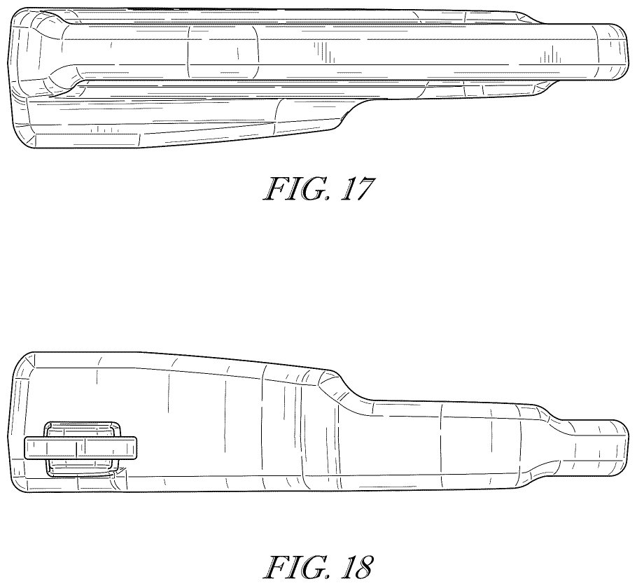

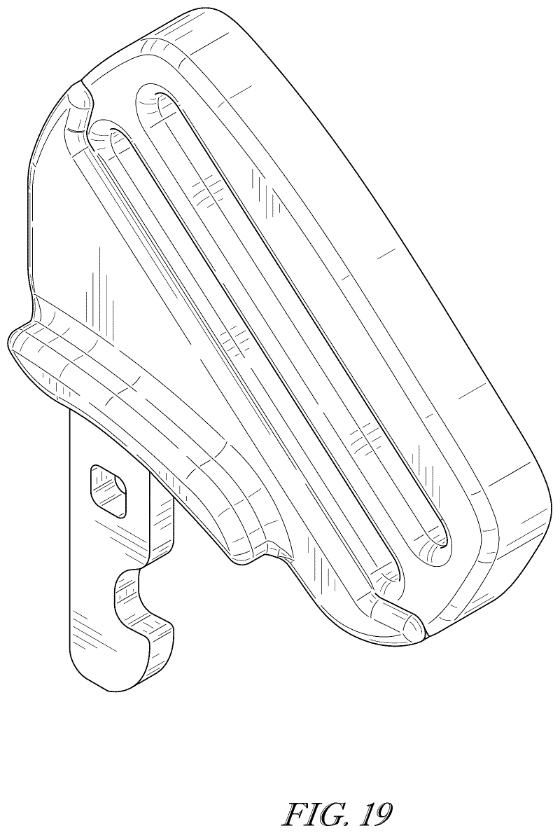

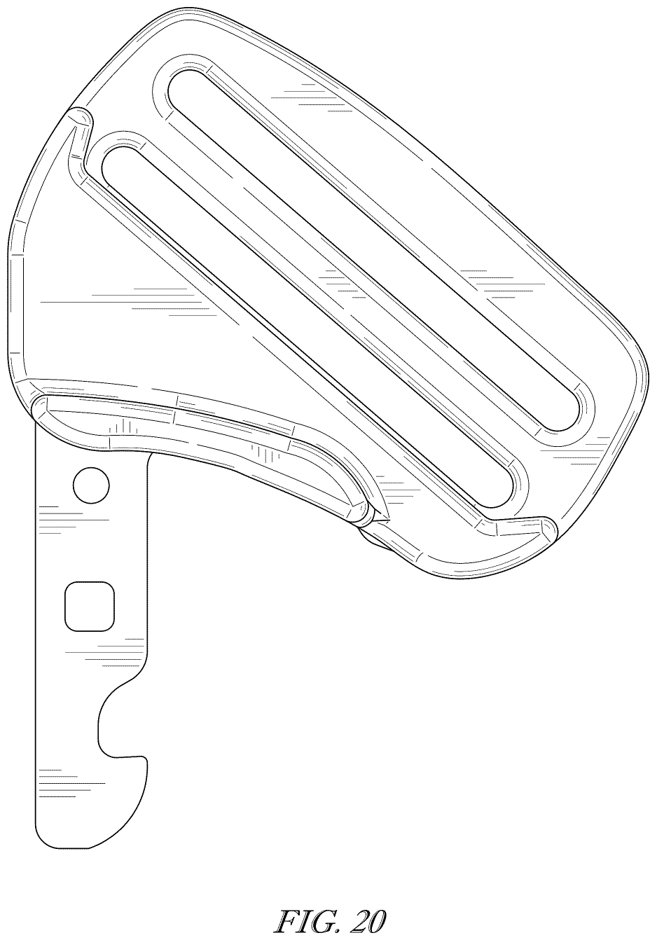

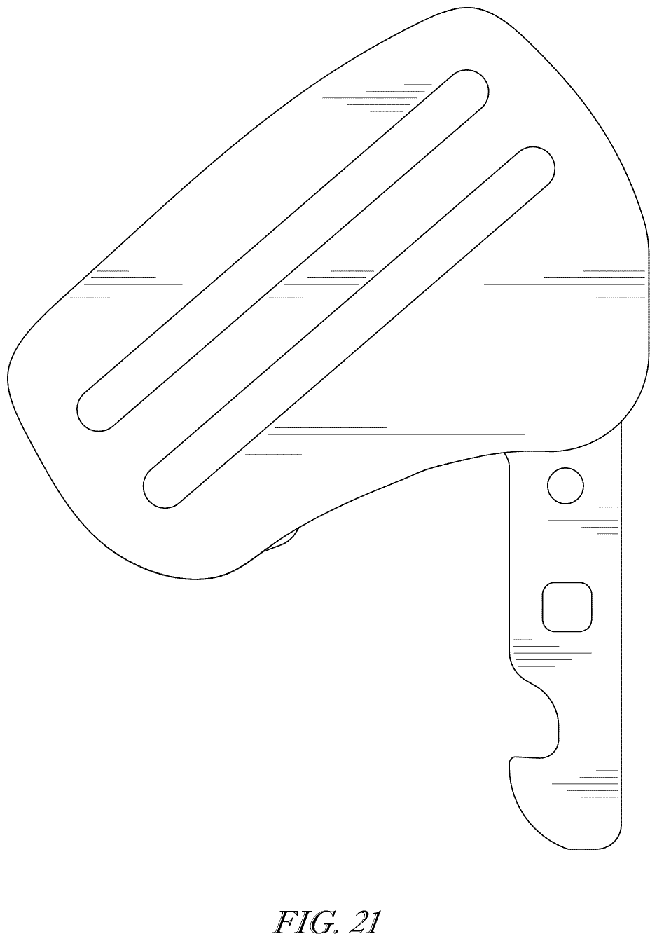

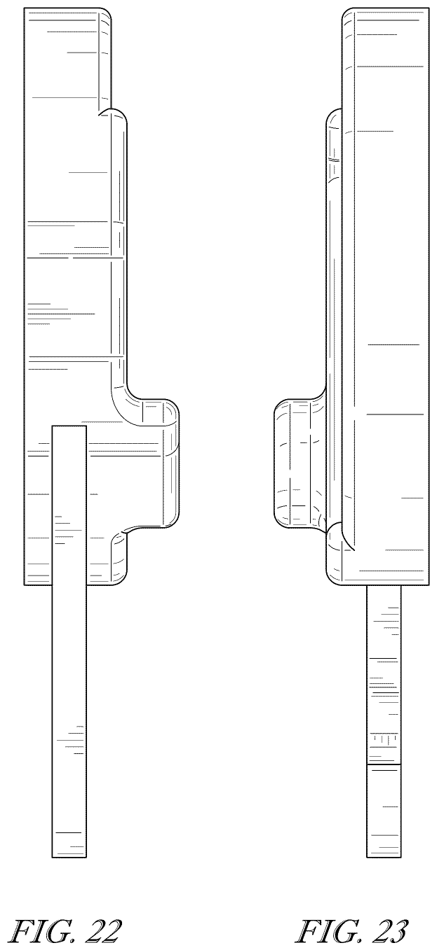

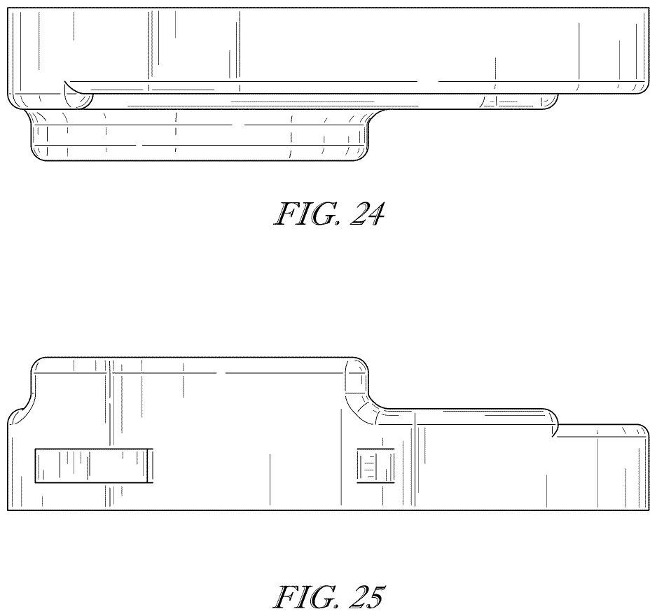

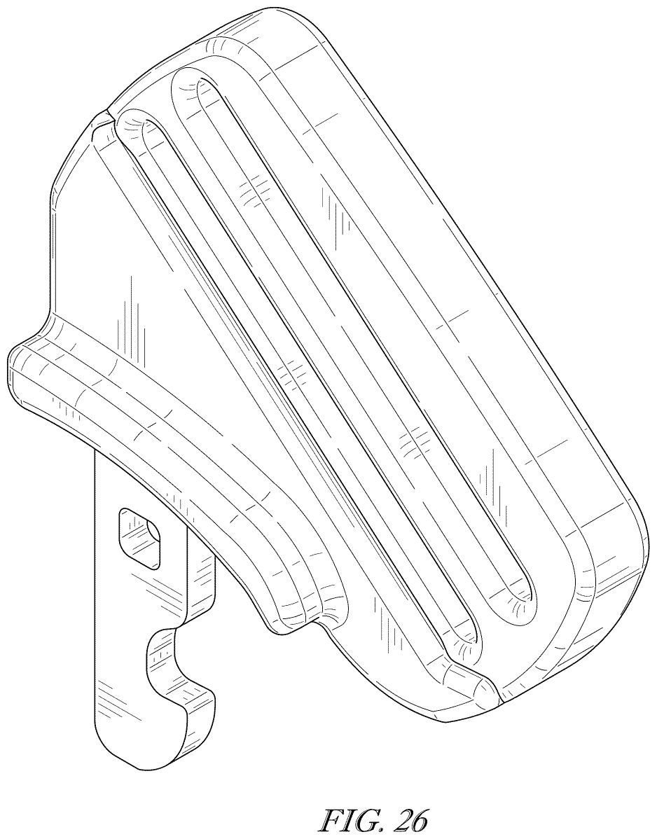

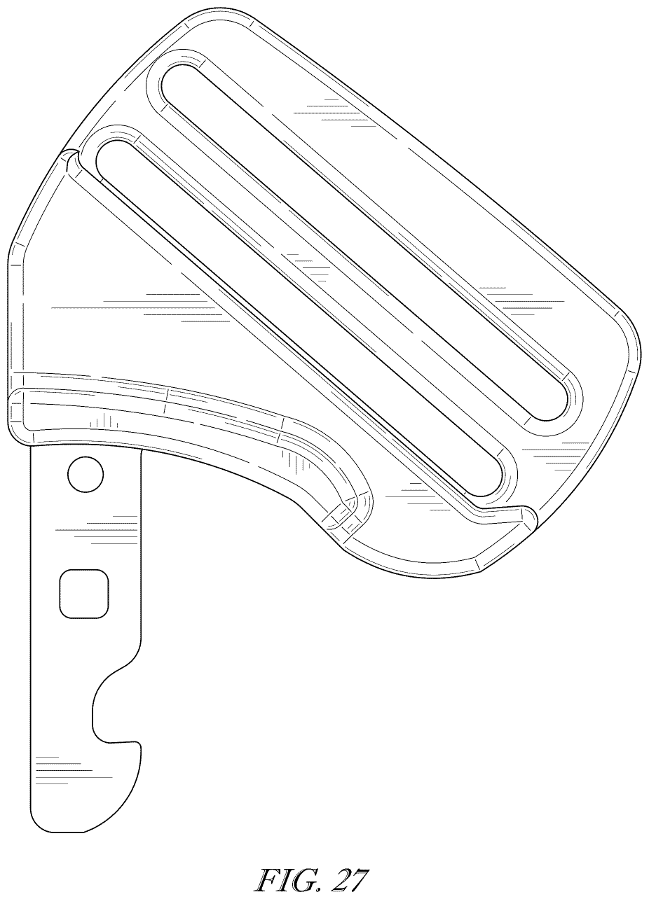

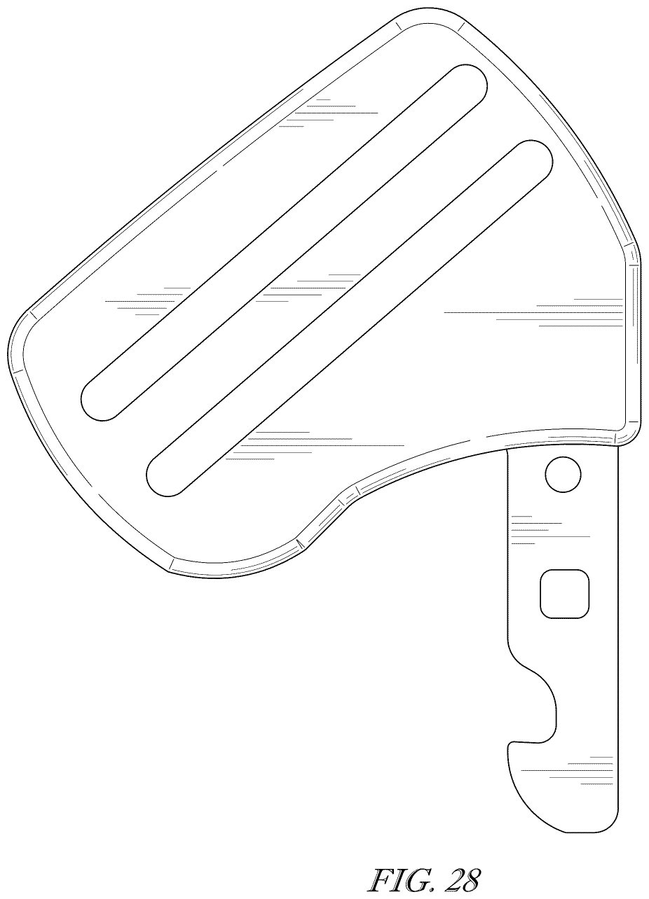

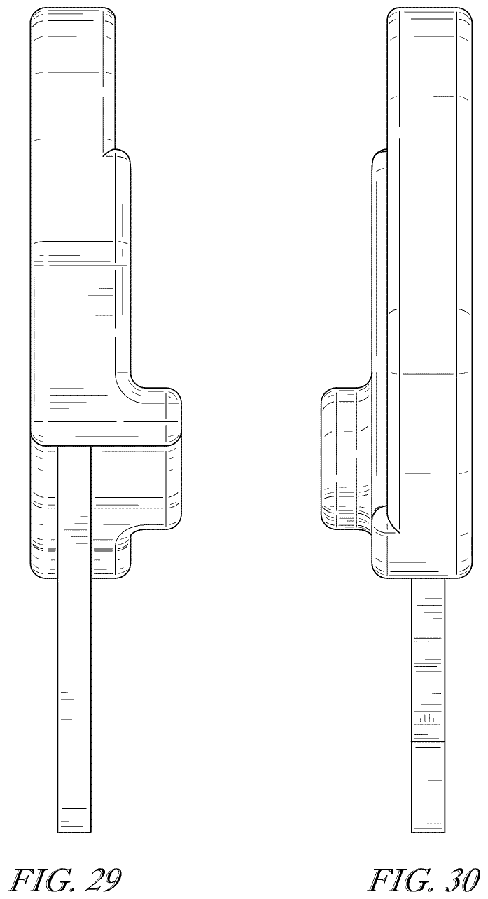

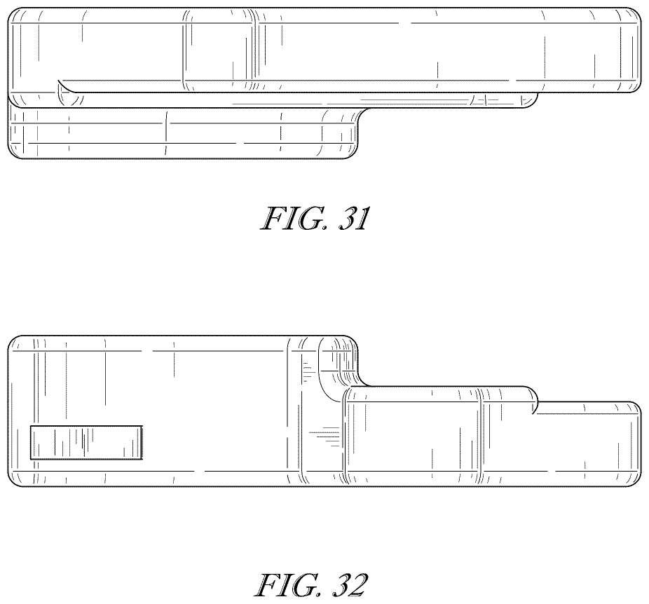

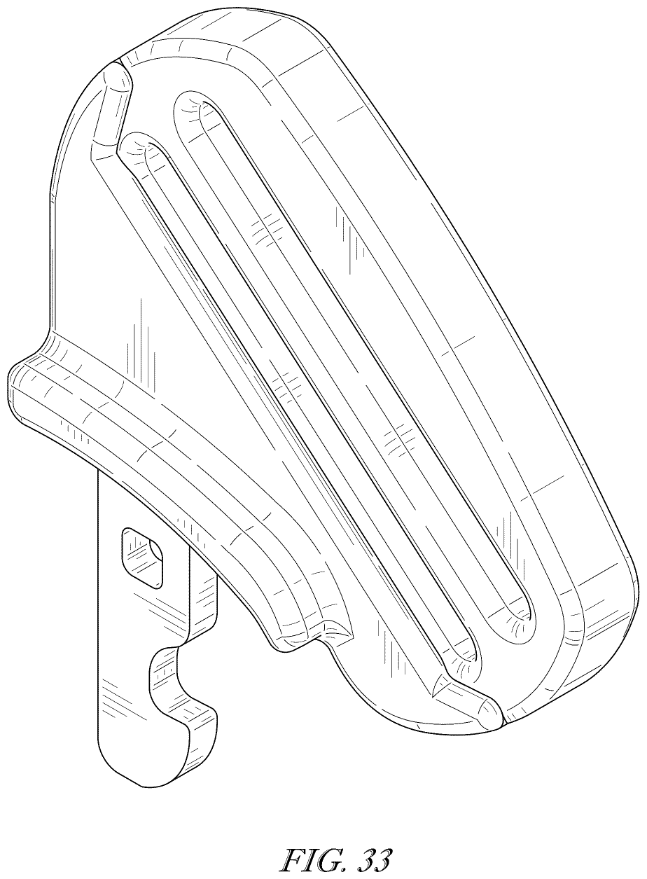

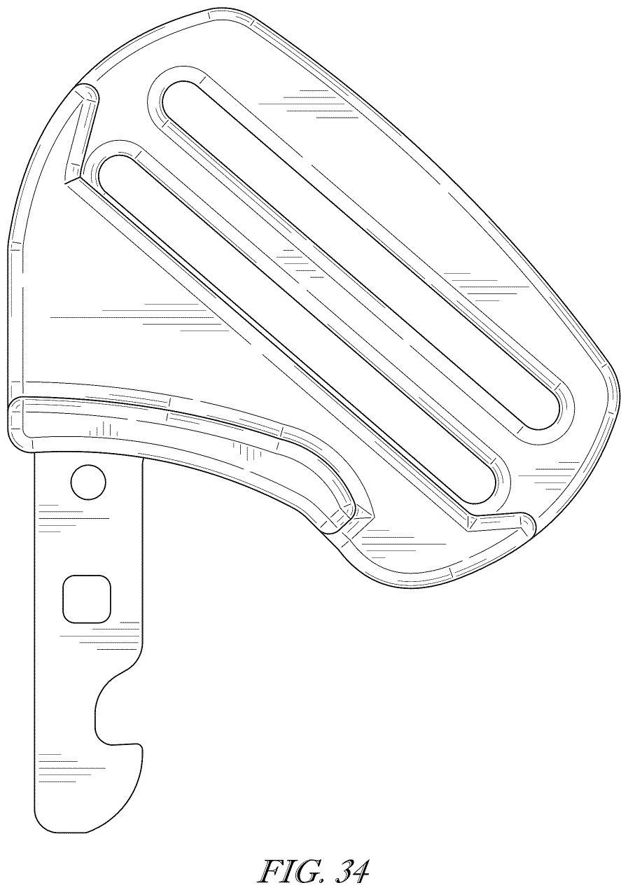

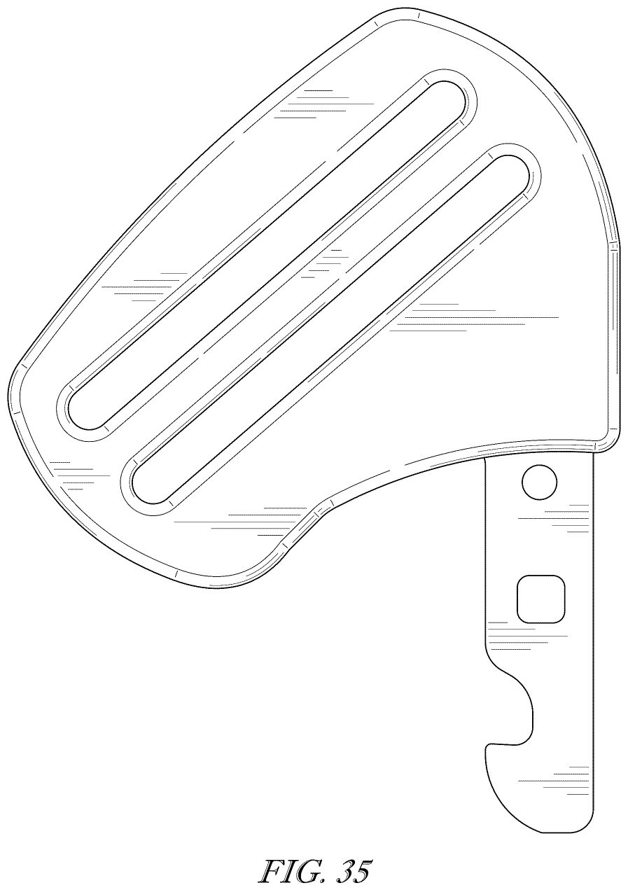

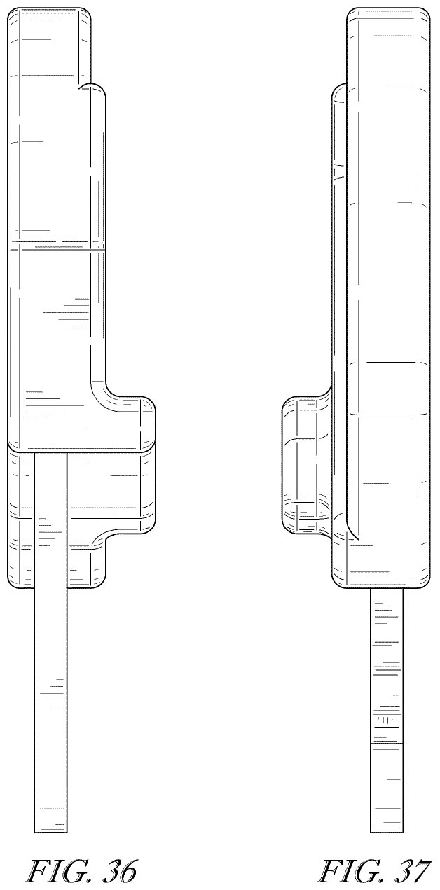

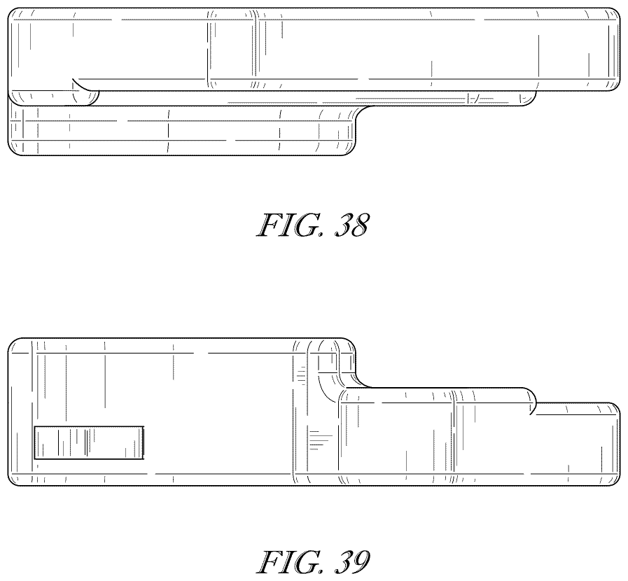

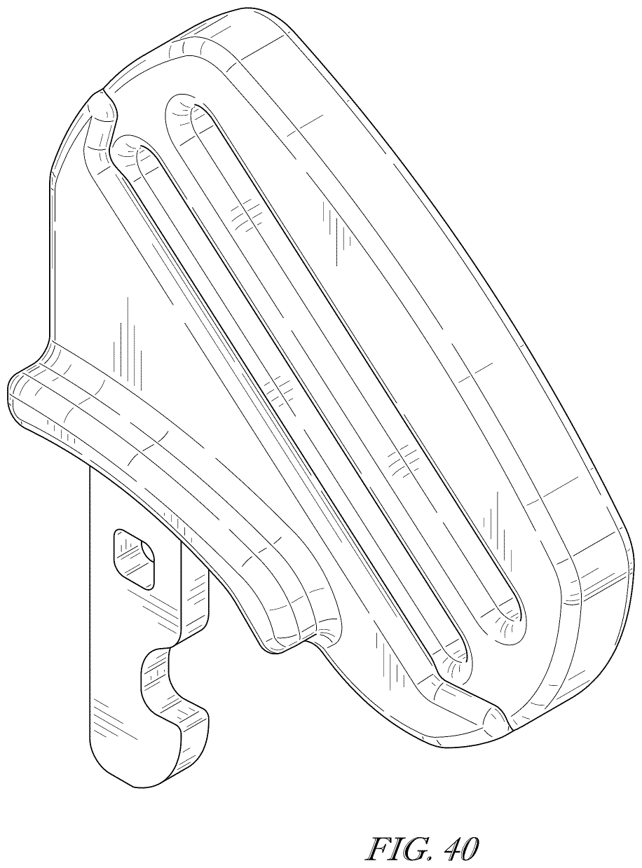

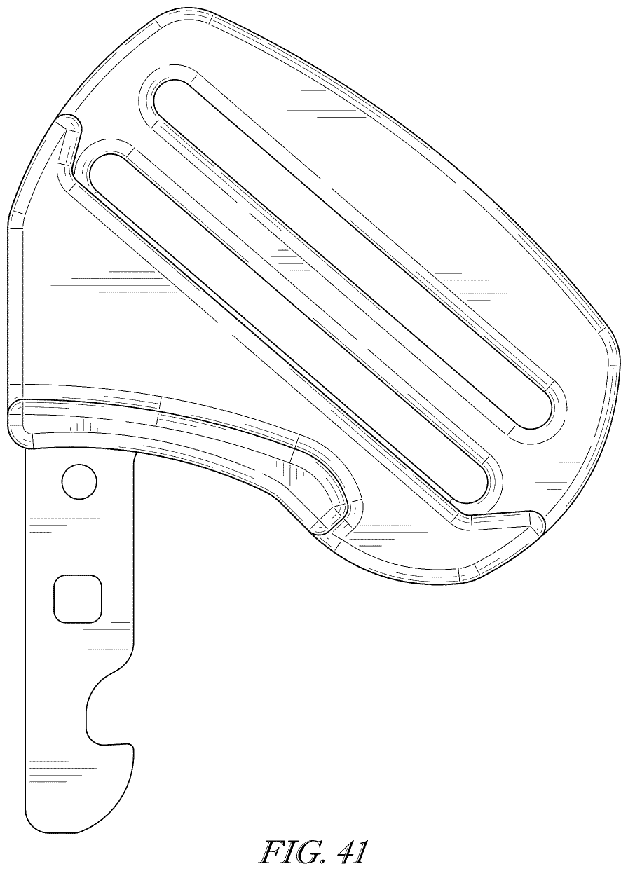

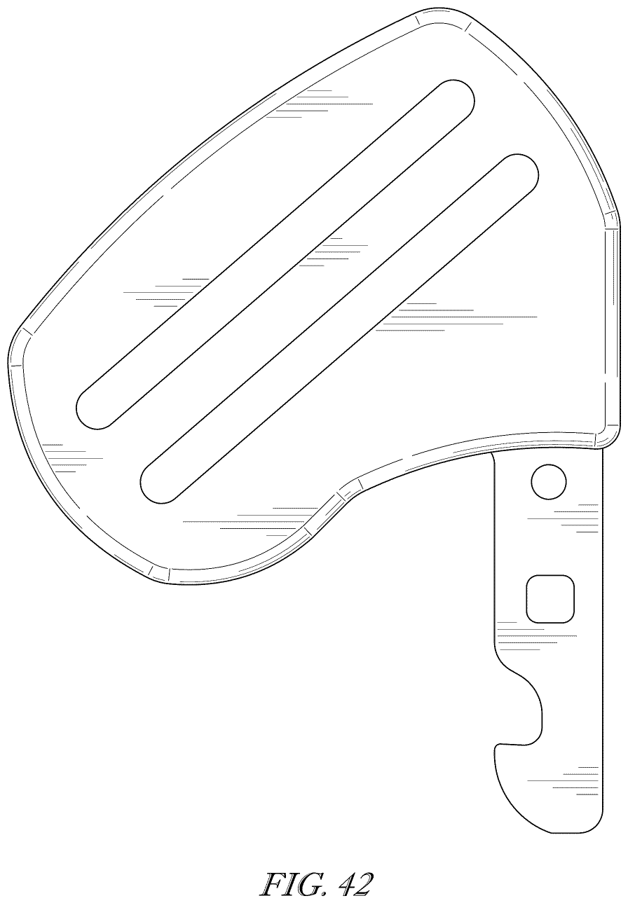

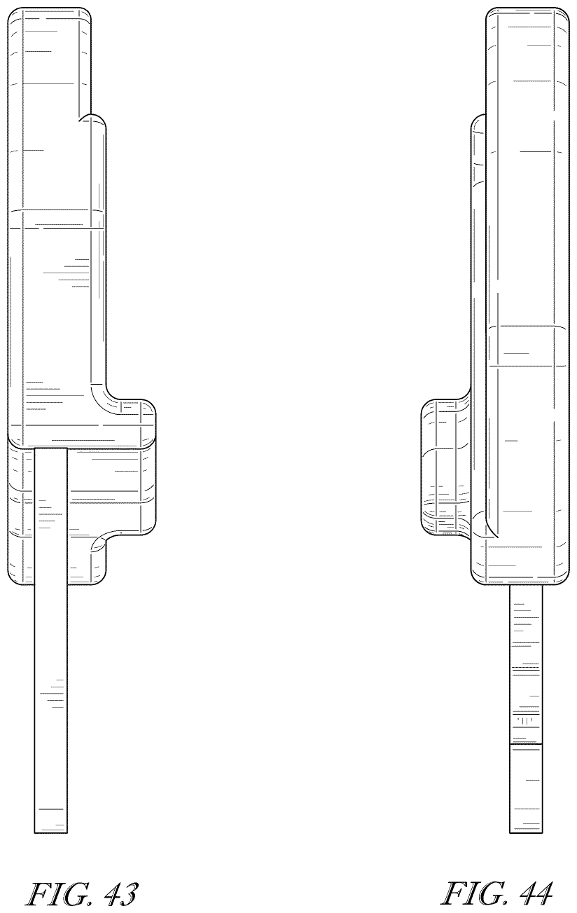

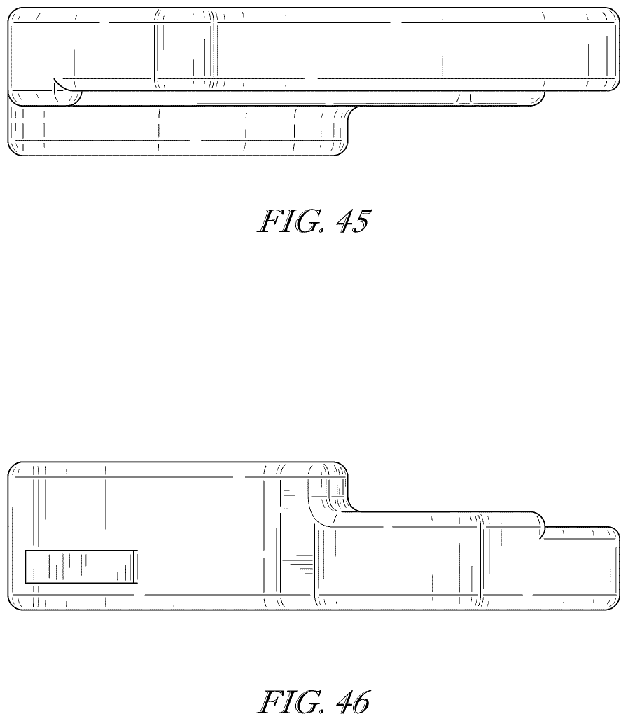

In some embodiments, the first base or mount cover may include a front segment 258 and a rear segment 260 coupled to the front segment 258 as shown in FIGS. 8 and 9. The front segment 258 and the rear segment 260 may cooperate to define first and second strap receiver slots 248, 250 and may cooperate to cantilever first lock tab.

The front segment 258 has an outer face 294 configured to face away from the child and an inner face 296 configured to engage the rear segment 260. The front segment 258 is formed to include a front first strap-receiver aperture 248A that opens into and extends through the outer face 294 and the inner face 296 so that the first side strap can be fed therethrough. The front segment 258 is further formed to include a front second strap-receiver aperture 250A spaced apart from the front first strap-receiver aperture 248A and opens into and extends through the outer face 294 and the inner face 296 so that the first side strap can be fed therethrough.

The rear segment 260 has an outer face 268 configured to face towards the child and a first inner face 266 configured to engage the inner face 296 of the front segment 258. The rear segment 260 is formed to include a rear first strap-receiver aperture 248B that opens into and extends through the outer face 268 and the first inner face 266 so that the first side strap can be fed therethrough. The rear segment 260 is further formed to include a rear second strap-receiver aperture 250B spaced apart from the rear first strap-receiver aperture 248B and opens into and extends through the outer face 268 and the first inner face 266 so that the first side strap can be fed therethrough.

When the first base is assembled, the front first strap-receiver aperture 248A and the rear first strap-receiver aperture 248B cooperate to form the first strap-receiver slot 248. Likewise, the front second strap-receiver aperture 250A and the rear second strap-receiver aperture 250B cooperate to form the second strap-receiver slot 250. The first side strap is fed through the first strap-receiver slot 248 from the outer face 268 of the rear segment 260 to the outer face 294 of the front segment 258. The first side strap is also fed through the second strap-receiver slot 250 from the outer face 294 of the front segment 258 to the outer face 268 of the rear segment 260. Accordingly, a portion of the first side strap rests along the outer face 294 of the front segment 258 between the front first strap-receiver aperture 248A and the front second strap-receiver aperture 250A.

The rear segment 260 is formed to include a first tab-receiving anchor 270 that is configured to cantilever the first lock tab to the first strap anchor 232. A second inner face 272 is located between the first inner face 266 and the outer face 268. The first inner face 266 and the second inner face 272 are interconnected with an outer sidewall 274 extending therebetween. An inner sidewall 276 which also defines the rear second-strap receiver aperture 250B is spaced inwardly from the outer sidewall 274 and extends from the second inner face 272 towards the first inner face 266. Accordingly, the first tab-receiving anchor 270 is defined by the inlay formed between the outer sidewall 274 and the inner sidewall 276. The outer sidewall 274 is non-contiguous such that a gap 290 is defined at a lower end of the rear segment 260 to allow the first lock tab to extend therethrough.

The second strap anchor 240 includes a second base or mount cover 252 formed to include a first strap-receiver slot 254 and a second strap-receiver slot 256 and the second lock tab 242 is cantilevered to a middle section of the second base 252 as shown in FIGS. 10 and 11. The second side strap is passed through and slides in the first strap-receiver slot 254 and the second strap-receiver slot 256 formed in the second base 252. In illustrative embodiments, the second lock tab 242 is made of a metal material and the second base 252 is made of a plastics material.

The second base 252 includes a front segment 262 and a rear segment 264 coupled to the front segment 262 as shown in FIGS. 10 and 11. The front segment 262 and the rear segment 64 may cooperate to define first and second strap receiver slots 254, 256 and cooperate to cantilever the second lock tab.

The front segment 262 has an outer face 298 configured to face away from the child and an inner face 200 configured to engage the rear segment 264. The front segment 262 is formed to include a front first strap-receiver aperture 254A that opens into and extends through the outer face 298 and the inner face 200 so that the second side strap can be fed therethrough. The front segment 262 is further formed to include a front second strap-receiver aperture 256A spaced apart from the front first strap-receiver aperture 254A and opens into and extends through the outer face 298 and the inner face 200 so that the second side strap can be fed therethrough.

The rear segment 264 has an outer face 280 configured to face towards the child and a first inner face 278 configured to engage the inner face 200 of the front segment 262. The rear segment 264 is formed to include a rear first strap-receiver aperture 254B that opens into and extends through the outer face 280 and the first inner face 278 so that the second side strap 238 can be fed therethrough. The rear segment 264 is further formed to include a rear second strap-receiver aperture 256B spaced apart from the rear first strap-receiver aperture 254B and opens into and extends through the outer face 280 and the first inner face 278 so that the second side strap can be fed therethrough.

When the second base or anchor mount 252 is assembled, the front first strap-receiver aperture 254A and the rear first strap-receiver aperture 254B cooperate to form the first strap-receiver slot 254. Likewise, the front second strap-receiver aperture 256A and the rear second strap-receiver aperture 256B cooperate to form the second strap-receiver slot 256. The second side strap is fed through the first strap-receiver slot 254 from the outer face 280 of the rear segment 264 to the outer face 298 of the front segment 262. The second side strap is also fed through the second strap-receiver slot 256 from the outer face 298 of the front segment 262 to the outer face 280 of the rear segment 264. Accordingly, a portion of the second side strap rests along the outer face 298 of the front segment 262 between the front first strap-receiver aperture 254A and the front second strap-receiver aperture 256A.

The rear segment 264 is formed to include a second tab-receiving anchor 282 that is configured to cantilever the second lock tab to the second strap anchor 240. A second inner face 284 is located between the first inner face 278 and the outer face 280. The first inner face 278 and the second inner face 284 are interconnected with an outer sidewall 286 extending therebetween. An inner sidewall 288 which also defines the rear second-strap receiver aperture 256B is spaced inwardly from the outer sidewall 286 and extends from the second inner face 284 towards the first inner face 278. Accordingly, the second tab-receiving anchor 282 is defined by the inlay formed between the outer sidewall 286 and the inner sidewall 288. The outer sidewall 274 is non-contiguous such that a gap or recess 292 is defined at a lower end of the rear segment 260 to allow the second lock tab 242 to extend therethrough. The recess 292 may surround only the second strap-receiving slot and may be spaced apart from the first strap-receiving slot. In other embodiments, the recess 292 may surround both the first and second strap-receiving slots.

In the illustrative embodiment, each strap anchor 32, 40 includes two strap-receiver slots 48, 50. In other embodiments, each strap anchor 32, 40 may include three, four, five, or more strap-receiver slots.

Daily use of an infant carrier or convertible car seat (i. e, the child restraint 10) can be a difficult task buckling a child in the child restraint 10. Caregivers attend to loosen the side straps, unbuckle their child and go on with their daily function, while comparative strap anchors slide down towards the seat bottom 16. Having to buckle and unbuckle an infant and or toddler multiple times a day while reaching under the child to find the strap anchors is a pain point for caregivers as well as the strap anchors getting twisted backwards in the harness webbing.

The disclosed strap anchors 32, 40 with the side straps weaved through the strap-receiver slots 48, 50 take on friction to block the strap anchors 32, 40 from sliding and twisting. The strap anchors 32, 40 can easily be adjusted to any predetermined height as needed. The strap-receiver slots 48, 50, in each strap anchor 32, 40 add slight friction between the strap anchor 32, 40 and the side straps to block the strap anchor 32, 40 from sliding down the side straps. This also blocks caregivers from digging the strap anchors 32, 40 out from underneath the child when the caregiver is attempting to change the child-restraint harness to the closed-child restraining mode.

The friction also allows for the strap anchor 32, 40 to remain stationary in the last position it was left in relative to the side strap. Having two or more strap-receiver slots 48, 50 in each strap anchor 32, 40 also blocks the strap anchor 32, 40 from getting twisted backwards on the side strap. Finally, the strap-receiver slots 48, 50 still allow a caregiver to freely move the side strap between the strap-receiver slots 48, 50 to adjust the position of the strap anchors 32, 40 upon additional pull force on the strap anchors 32, 40 or the side straps by the caregiver that is greater than the friction between the strap anchors 32, 40 and the side straps.

1. A child restraint comprising
a juvenile vehicle seat adapted to be secured to a vehicle seat and formed to include a child-receiving space configured to hold a child for transportation in a vehicle, and
a child-restraint harness coupled to the juvenile vehicle seat and configured to secure the child to the juvenile vehicle seat, the child-restraint harness including a crotch strap fixed to the juvenile vehicle seat, a first shoulder strap fixed the juvenile vehicle seat and spaced apart from the crotch strap, a second shoulder strap fixed to the juvenile vehicle seat and spaced apart from the crotch strap and the first shoulder strap, and a strap retainer configured to attach selectively the first shoulder strap and the second shoulder strap to the crotch strap,
wherein the strap retainer includes a crotch buckle coupled to the crotch strap, a first shoulder-strap anchor coupled to the first shoulder strap, and a second shoulder-strap anchor coupled to the second shoulder strap,
wherein the first and second shoulder-strap anchors each include an anchor mount coupled to the first shoulder strap and the second shoulder strap, respectively, and an anchor latch coupled to the anchor mount and configured to engage selectively with the crotch buckle to block separation of the first and second shoulder-strap anchors from the crotch buckle, and
wherein each anchor mount is formed to include a first strap-receiving slot and a second strap-receiving slot, and the first shoulder strap and the second shoulder strap are threaded through the first strap-receiving slot and the second strap-receiving slot of each anchor mount, respectively, to apply a friction force between each anchor mount and the first shoulder strap and the second shoulder strap, respectively, to block movement of each anchor mount along the first shoulder strap and the second shoulder strap, respectively.

2. The child restraint of claim 1, wherein the anchor latch includes a first lateral edge and an opposite second lateral edge, the first and second lateral edges each having a linear segment along at least a portion of an extent thereof, and the first and second strap-receiving slots being arranged to lie at an acute angle relative to the linear segment when measured in a lateral direction away from the anchor latch and toward the first and second strap-receiving slots.

3. The child restraint of claim 2, wherein the acute angle is within a range of about 45 degrees to about 55 degrees.

4. The child restraint of claim 3, wherein the acute angle is about 50 degrees.

5. The child restraint of claim 1, wherein the first and second strap-receiving slots are parallel to one another and the first and second strap-receiving slots have substantially equal lengths.

6. The child restraint of claim 1, wherein the first and second strap-receiving slots have substantially equal widths.

7. The child restraint of claim 6, wherein the first and second shoulder straps have a thickness that is no more than 90% of the widths of the first and second strap-receiving slots.

8. The child restraint of claim 1, wherein the anchor mount and the anchor latch are formed integrally with one another and are made of at least one metal material.

9. The child restraint of claim 8, wherein the anchor mount includes a mount cover made of one or more polymeric materials overmolded onto the at least one metal material.

10. The child restraint of claim 8, the anchor mount includes a mount cover made of one or more polymeric materials, and the mount cover includes a front segment and a rear segment.

11. The child restraint of claim 10, wherein the rear segment is formed to include a recess that receives a portion of the at least one metal material.

12. The child restraint of claim 11, wherein the recess surrounds only the second strap-receiving slot and is spaced apart from the first strap-receiving slot.

13. The child restraint of claim 1, wherein the anchor mount includes an upper segment partially defining the first strap-receiving slot, a lower segment coupled to the anchor latch and partially defining the second strap-receiving slot, and a medial segment spaced apart from the upper segment and the lower segment and partially defining the first strap-receiving slot and the second strap-receiving slot.

14. The child restraint of claim 13, wherein the medial segment includes, a front planar edge, a rear planar edge, an upper curved edge extending between upper ends of the front and rear planar edges, and a lower curved edge extending between lower ends of the front and rear planar edges.

15. The child restraint of claim 14, wherein the upper curved edge and the lower curved edge each include a forward end having a first radius of curvature and a rear end having a second radius of curvature greater than the first radius of curvature.

16. The child restraint of claim 14, wherein the upper segment has a lower curved edge and the lower segment has an upper curved edge to provide the first and second strap-receiving slots with a funnel-shaped forward end and a funnel shaped rear end.

17. The child restraint of claim 16, wherein the first and second strap-receiving slots have a smallest width located closer to the front planar edge than the rear planar edge.

18. The child restraint of claim 16, wherein the upper curved edge of the medial segment and the lower curved edge of the medial segment each include a forward end having a first radius of curvature and a rear end having a second radius of curvature greater than the first radius of curvature, and the lower curved edge of the upper segment and the lower curved edge of the lower segment each include a forward end having the first radius of curvature and a rear end having the second radius of curvature.

19. A child-restraint harness comprising:
a strap,
a buckle, and
a strap anchor coupled to the strap,
wherein the strap anchor includes an anchor mount coupled to the strap and an anchor latch coupled to the anchor mount and configured to engage selectively with the buckle to block separation of the strap anchor from the buckle, and
wherein the anchor mount is formed to include a first strap-receiving slot and a second strap-receiving slot, and the strap is threaded through the first strap-receiving slot and the second strap-receiving slot of the anchor mount to apply a friction force between the anchor mount and the strap to block movement of the anchor mount along the strap.

20. The child-restraint harness of claim 19, wherein the strap anchor is configured to translate along the strap upon application of a force on the strap anchor of at least 0.2 lb and no more than 5 lbs in a lengthwise direction of the strap.
